(19) United States
(12) Patent Application Publication
(10) Pub. No.: US 2003/0021253 A1
(43) Pub. Date: Jan. 30, 2003

(54) Method of transmitting data from server of virtual private network to mobile node

(76) Inventor: Tae-Sung Jung, Sangju-shi (KR)

Correspondence Address: Paul J. Farrell, Esq., DILWORTH & BARRESE, LLP, 333 Earle Ovington Blvd., Uniondale, NY, 11553, US

(21) Appl. No.: 10/187,700

(22) Filed: Jul. 2, 2002

(30) Foreign Application Priority Data
Jul. 3, 2001 (KR) 39567/2001

(51) Int. Cl. H04Q 7/24

(52) U.S. Cl. 370/338; 370/200

(57) ABSTRACT

A method of transmitting data from a Virtual Private Network (“VPN”) server to a Mobile Node (“MN”) is provided. Upon sensing generation of data destined for the MN in the VPN server, a Customer Premise Equipment (“CPE”) router requests an Internet Service Provider (“ISP”) router connected to a VPN to search for an address of a Foreign Agent (“FA”) to which the MN belongs. The ISP router searches for the FA address through a Home Agent (“HA”) and routes the data to the FA identified by the searched FA address. The FA then locates the MN and forwards the data to the MN.

### PRIORITY

This application claims priority to an application entitled “Method of Transmitting Data from Server of Virtual Private Network to Mobile Node” filed in the Korean Industrial Property Office on Jul. 3, 2001 and assigned Serial No. 2001-39567, the contents of which are hereby incorporated by reference.

### BACKGROUND OF THE INVENTION

1. Field of the Invention

The present invention relates generally to a data transmission method in a VPN (Virtual Private Network), and in particular, to a data transmitting method to a mobile node over a VPRN (Virtual Private Routed Network).

2. Description of the Related Art

As is implied by its name, a mobile node (“MN”) is characterized by its mobility. With mobility guaranteed, a mobile user uses the MN for a voice call or data communication. In light of no limitations in a location, MNs allow multiple users to receive data services such as Internet access, while roaming. Methods and systems for providing mobile services more reliably are currently being developed. Assignment of permanent Internet Protocol (“IP”) addresses to MNs is essential in stably providing a data service with ensured mobility. Therefore, studies are made on assignment of mobile IP addresses to MNs.

FIG. 1 illustrates the configuration of a mobile IP network for assigning mobile IP addresses to MNs. The configuration of the network and location registration will be described. Referring to FIG. 1, an MN 10 performs a location registration with a base station at system initialization, or when location registration is needed. Since the MN 10 is mobile station as stated above, it may send a location registration signal when it is away from its home network, for example, from the U.S. even though it has been registered with a service provider in Korea. This is possible if a particular service protocol is set between mobile service providers. The location registration will be described with reference to FIG. 1.

The MN 10 wirelessly sends a Registration Request to a Foreign Agent (“FA”) 20 acting as a base station. The FA 20 then forwards the Registration Request with the address of the FA 20 included to a Home Agent (“HA”) 30 of the MN 10 over a predetermined network 25. The HA 30 stores the address of the FA 20 from the data received from the FA 20. That is, the HA 30 stores a temporary address of the MN (which is referred to as a care-of-address (“COA”)) This temporary address is typically the address of the FA 20. Then the HA 30 sends a Registration Reply for the Registration Request to the FA 20. By this procedure, the location of the MN 10 is registered. In one aspect, the MN 10 can receive data from a Correspondent Node (“CN”) 40 only after the location registration with the HA 30. The CN 40 is a host in a general network, which sends/receives data to/from the MN 10. A procedure for data transmission between the MN 10 and the CN 40 will be described with reference to FIG. 2.

FIG. 2 is a schematic diagram illustrating data transmission over a network for assigning a mobile IP address to an MN. First, a description will be made below of data transmission between the CN 40 and the MN 10 after the MN's registration with the HA in the procedure explained above. Networks 25 between the FA 20 and the HA 30, between the HA 30 and the CN 40, and between the FA 20 and the CN 40 may be the same or different. In one aspect, the networks 25 are IP networks.

The CN 40 is a computer that is to send data to the MN 10. For data transmission, the CN 40 sends the data to the HA 30 over the IP network 25. The HA 30, which has the addresses of FAs 20 under its management, forwards the data to the IP address of an FA 20 that the MN 10 belongs to. Then the FA 20 forwards the data to the MN 10. The data includes the address of the CN 40. On the other hand, when the MN 10 is to send data to the CN 40, it sends the data to the FA 20 and the FA 20 forwards the data to the CN 40 without passing through the HA 30 because the MN 10 has requested data transmission with the destination address included, for example, the address of the CN 40. Accordingly, data is transmitted and received using different routes.

As the Internet can be accessed at lower costs all over the world, communication networks including private networks are being developed to accommodate the Internet service. In this context, studies are vigorously made on VPNs with no limitations in location and assignment of permanent IP addresses to MNs that roam.

There are two kinds of VPNs: one is a dedicated Wide Area Network (“WAN”) connecting sites by permanent links and the other is a dial network using dial-up connections over the PSTN (Public Switched Telephone Network). Connections between IP-based VPNs through routers and data transmission over the VPNs will be described below in connection with FIG. 3.

In FIG. 3, an IP backbone is connected to routers. Internet Service Provider (“ISP”) routers 120, 130 and 140 are edge routers connected to Customer Premise Equipment (“CPE”) routers 110, 150, 160 and 170. A CPE router connects a mobile subscriber at a certain point to a VPN, and an ISP router is an equipment operated by an ISP to route data received from a CPE router to a desired VPN. The ISP routers 120, 130 and 140 in an IP network 100 carry out data transmission/reception by IP tunneling. A stub link is established between an ISP router and a CPE router. When necessary, a backup link is established between a CPE router and an ISP router, and a backdoor link is established between CPE routers at different locations. Accordingly, the configured network shown in FIG. 3 generally provides an Internet service and various communications.

The existing VPNs support data communication for users over the Internet by forming IP tunnels wherever the users are located. However, since MNs roam, it is impossible to store all information about the MNs to an ISP in a certain area for data transmission/reception. This means that a server in a VPN cannot initiate data transmission to an MN.

### SUMMARY OF THE INVENTION

It is, therefore, an object of the present invention to provide a method of enabling a server in a VPN to carry out an initial data transmission to an MN.

It is another object of the present invention to provide a method of enabling a server in a VPN to initially send data to an MN with no communication link established between the server and the MN.

To achieve the above and other objects, there is provided a method of transmitting data from a VPN server to an MN. Upon sensing generation of data destined for the MN in the VPN server, a CPE router requests an ISP router connected to a VPN to search for an address of an FA to which the MN belongs. The ISP router searches for the FA address through an HA and routes the data to the FA identified by the searched FA address. The FA then locates the MN and forwards the data to the MN.

### BRIEF DESCRIPTION OF THE DRAWINGS

The above and other objects, features and advantages of the present invention will become more apparent from the following detailed description when taken in conjunction with the accompanying drawings in which:

FIG. 1 schematically illustrates the configuration of a mobile IP network for assigning mobile IP addresses to MNs;

FIG. 2 schematically illustrates data transmission over a network for assigning mobile IP addresses to MNs;

FIG. 3 schematically illustrates the configuration of a network where IP-based VPNs are connected through routers;

FIG. 4 schematically illustrates the configuration of a VPN over which a server sends data to an MN in one embodiment;

FIG. 5 illustrates the devices of FIG. 4 with their IP addresses assigned;

FIG. 6 illustrates the format of an Inquire COA message by which the IP address of an FA to which an MN belongs is inquired according to an embodiment of the present invention;

FIG. 7 illustrates the format of an Inform COA message according to one embodiment of the present invention; and

FIG. 8 is a diagram illustrating a signal flow for sending data from a server to an MN over the VPN according to one embodiment of the present invention.

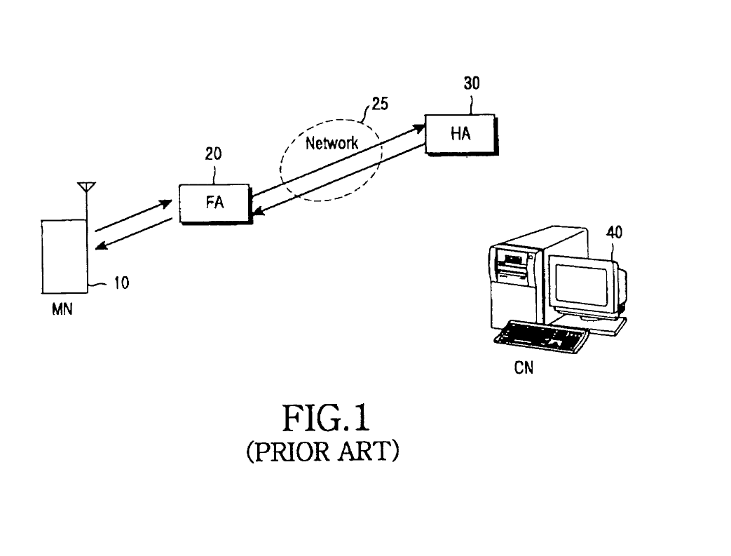

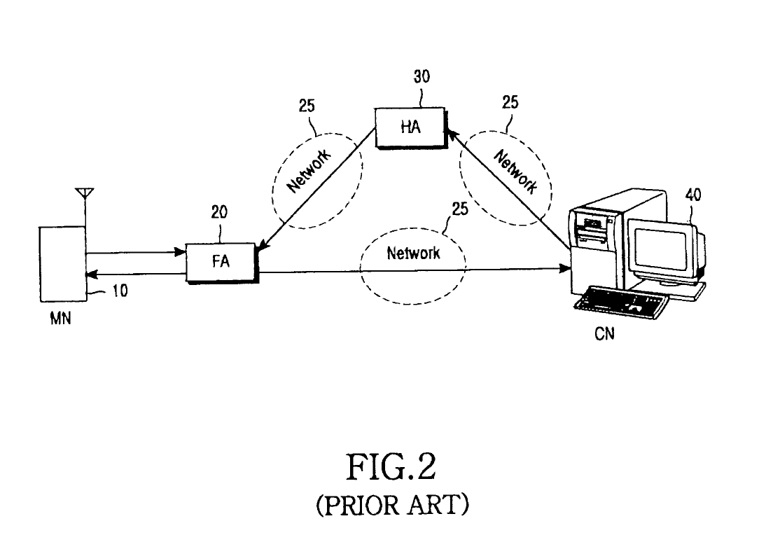

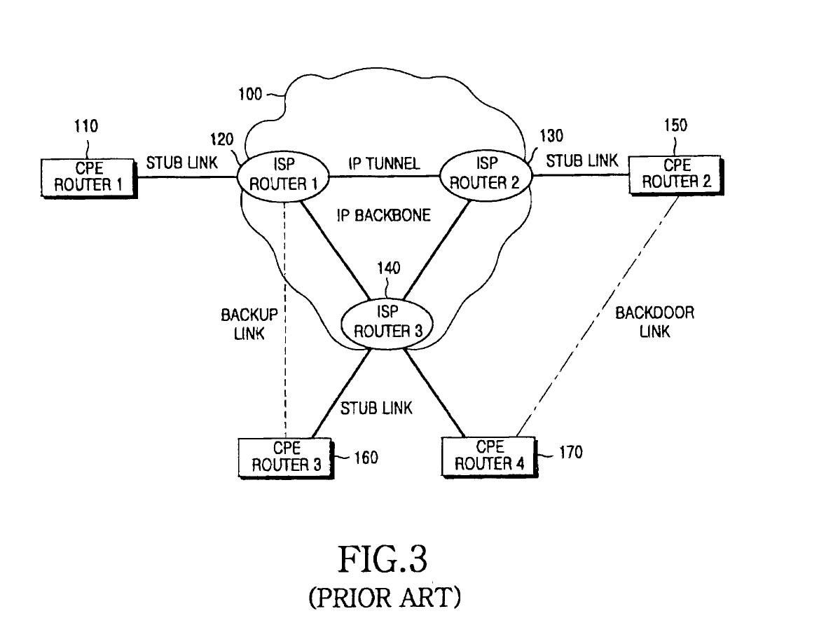

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

For clarity of description, a type of VPN, a Virtual Private Routed Network (“VPRN”) will be described. A VPRN is defined to be an emulation of a dedicated IP-based routed network between customer sites.

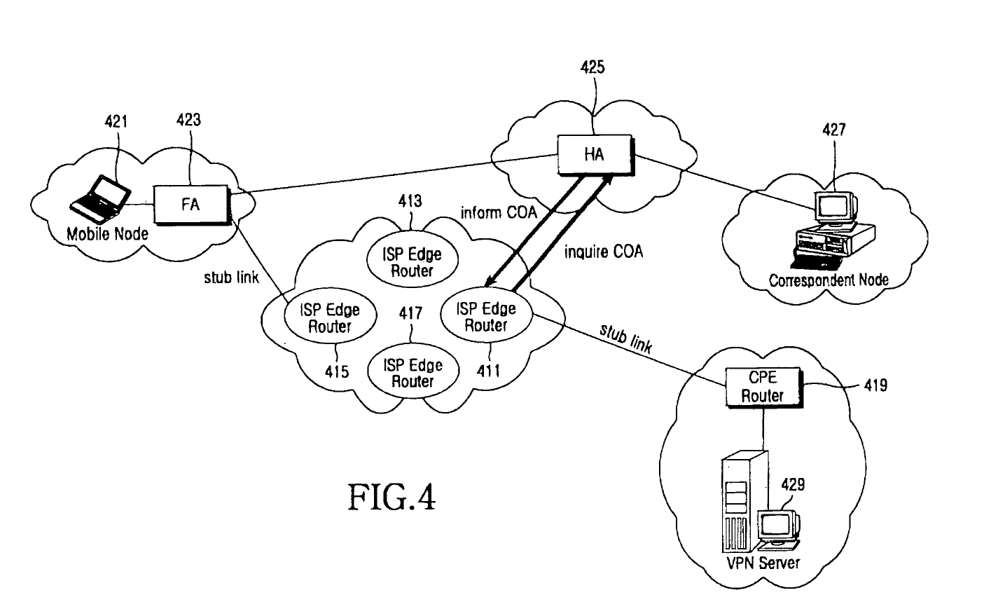

Referring to FIG. 4, an IP backbone is connected to routers. ISP edge routers 411, 413, 415 and 417 are connected to a CPE router 419. The CPE router 419, for example, is an equipment used for an MN 421 at a certain location to connect to a VPN. The ISP edge routers 411, 413, 415 and 417 are ISP-operated devices for connecting data received from the CPE router 419 to a desired VPN. The ISP edge routers 411, 413, 415 and 417 typically are an IP network and data transmission between them is carried out by IP tunneling. A stub link is established between the CPE router 419 and the ISP edge routers 411, 413, 415 and 417.

The MN 421 sends a Registration Request to an FA 423 and the FA 423 forwards the Registration Request with the address of the FA 423 to an HA 425 of the MN 421 over an IP network. The HA 425 stores the address of the FA 423 where the MN 421 is located, that is, the COA of the MN 421. Then the HA 425 sends a Registration Reply for the Registration Request to the FA 423. Thus, the MN 421 completes its location registration with the HA 425. In one aspect, the registration allows the MN 421 to receive data from a CN 427.

In one aspect, when a VPN server 429 connected to the CPE router 419 is to send data to the MN 421, the VPN server 429 obtains the address of the FA 423 to which the MN 421 belongs from the HA 425. Thus, it is possible for the VPN server 429 to initiate data transmission to the MN 421 at the address of the FA 423.

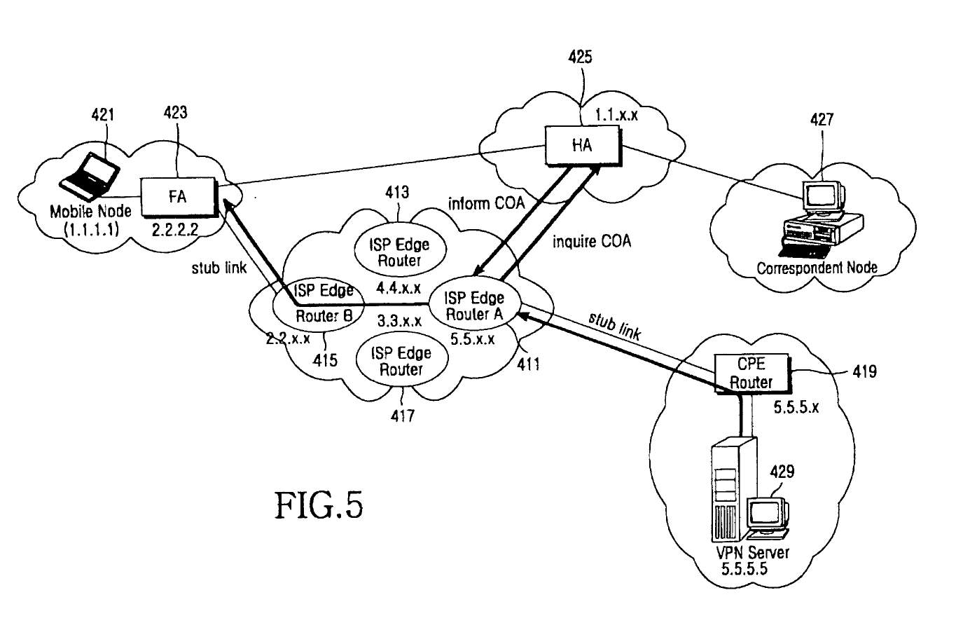

Now a description will be made of initial data transmission from the VPN server to the MN over a VPN with IP addresses assigned to them with reference to FIG. 5. FIG. 5 illustrates the devices of FIG. 4 with their IP addresses assigned.

Referring to FIG. 5, if the VPN server 429 at an IP address of 5.5.5.5, for example, has data destined for the MN 421, it must search for an FA to which the MN 421 belongs. The IP address of the MN 421 shown in FIG. 5, for example, is 1.1.1.1. To do so, the VPN server 429 requests its CPE router 419 to search for the FA 423 of the MN 421. Here, the CPE router 419 has an IP address of 5.5.5.X. The CPE router 419 sends a request to an ISP router A 411 at 5.5.X.X, to which the CPE router 419 is connected, to search for the FA 423 of the MN 421.

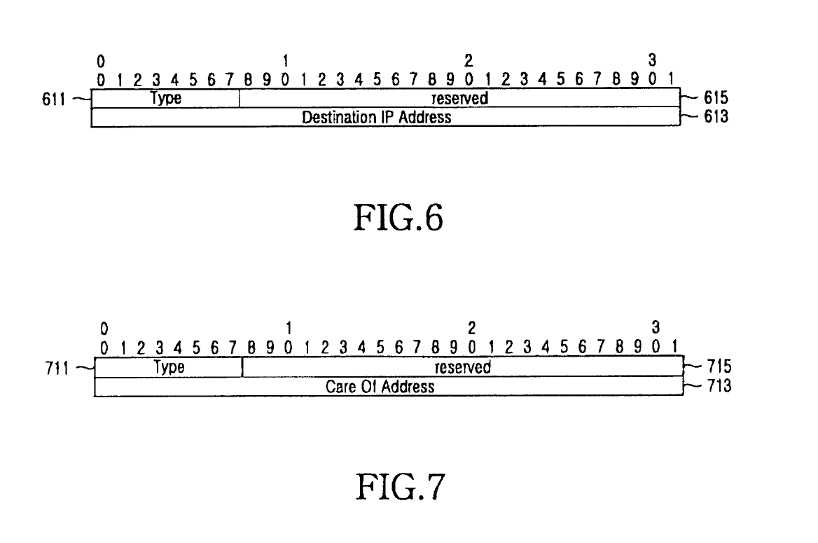

The ISP router A 411 sends a request to the HA 425 to search for the FA 423 by an Inquire COA message, telling it the IP address of the MN 421. The Inquire COA message will be described later referring to FIG. 6. For the VPN server 429 to detect the IP address of the FA 423, the ISP router A 411 requests the HA 425 at 1.1.X.X to search for the FA 423 of the MN 421. Here, the ISP router A 411 tells the HA 425 the IP address, 1.1.1.1 of the MN 421 to enable the HA 425 to detect the IP address of the FA 423. The HA 425 then notifies the ISP router A 411 of the IP address of the FA 423 by an Inform COA message. The Inform COA message will be described later referring to FIG. 7.

Upon receipt of the IP address of the FA 423, for example, 2.2.2.2 of the MN 421, the ISP router A 411 detects an ISP router corresponding to the IP address of the FA 423, that is, the ISP router B 415 among its connected ISP routers 413, 415 and 417. For example, the ISP router 415 has an IP address of 2.2.X.X. Then, a connecting path between the ISP routers is determined to allow communication from the FA 423 to the VPN Server 429. For example, it is determined that the ISP router A 411 is connected to the ISP router B 415, which is in turn connected to the CPE router 419, to thereby allow the VPN server 429 to send data to the ISP router B 415. Upon receipt of the data, the ISP router B 415 chooses the FA 423 according to the IP address of the MN 421 and sends the data to the FA 423. The FA 423 then forwards the data to the MN 421.

FIG. 6 illustrates the format of an Inquire COA message according to the embodiment of the present invention. Referring to FIG. 6, for the VPN server 429 to detect the IP address of the FA 423, the ISP router A 411 sends an Inquire COA message in the format illustrated in FIG. 6 to the HA 425. The Inquire COA message may be configured in any format for communicating a request, and thus need not be limited to the format shown in FIG. 6. The Inquire COA message comprises a message type area 611, a destination IP address 613 indicating the IP address of the MN 421, and a reserved area 615. With the IP address of the MN 421, the HA 425 can detect the FA to which the MN 421 belongs. That is, the HA 425 searches for the FA of the MN 421 among its stored FA IP addresses. Then, the HA 425 sends an Inform COA message responding to the Inquire COA message. The Inform COA message may also be configured in any format for communicating the information, and accordingly the format need not be limited to the one shown in FIG. 7.

FIG. 7 illustrates the format of the Inform COA message corresponding to the Inquire COA message directed from the ISP router A 411 to the HA 425 in one aspect. The HA 425 detects the FA of the MN 421 referring to the IP address of the MN 421 included in the Inquire COA message. Then, the HA 425 sends the Inform COA message including the IP address of the FA 423. Referring to FIG. 7, the Inform COA message is comprised of a message type area 711, a COA area 713 indicating the IP address of the FA 423, and a reserved area 715.

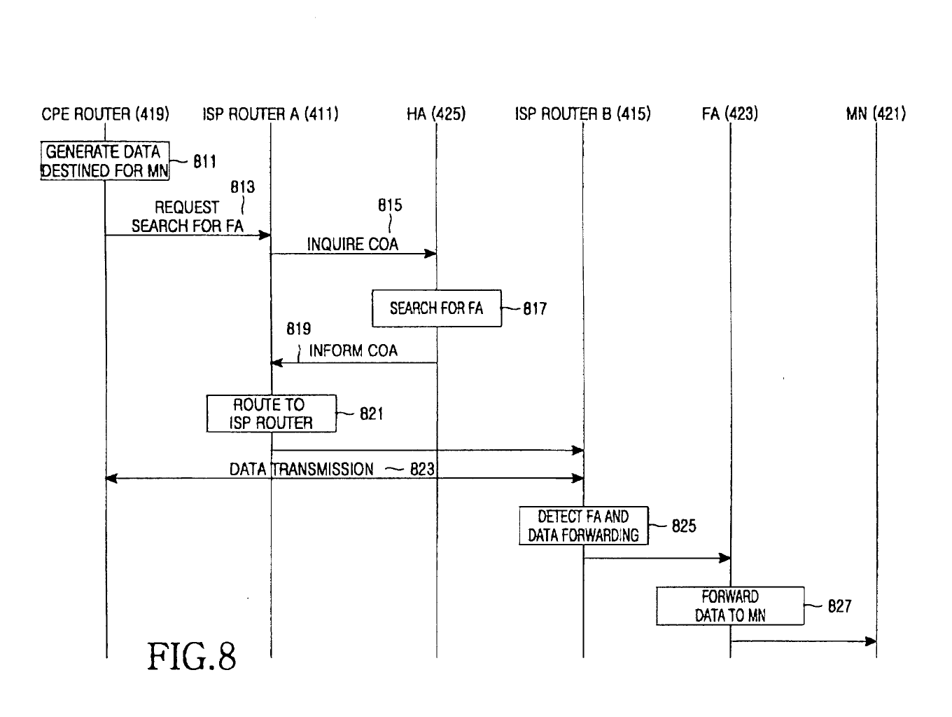

Now a description will be made of data transmission from the VPN server to a particular MN with reference to FIG. 8. FIG. 8 is a diagram illustrating a signal flow for data transmission from the VPN server to the MN according to the embodiment of the present invention. Referring to FIG. 8, upon generation of data destined for the MN 421 in the VPN server 429 in step 811, the CPE router 419 requests its connected ISP router A 411, that is, the ISP router A 411 to search for the FA to which the MN 421 belongs in step 813. Then, the ISP router A 411 sends an Inquire COA message to the HA 425 in step 815. The HA 425 then detects the IP address of the FA 423 of the MN 421 using the IP address of the MN 421 included in the Inquire COA message in step 817. In step 819, the HA 425 sends an Inform COA message including the IP address of the FA 423 to the ISP router A 411. The ISP router A 411 routes to an ISP router corresponding to the IP address of the FA 423, that is, the ISP router B 415 in step 821. Thus, connections are made between the ISP router A 411 and the ISP router B 415 and between the CPE router 419 and the ISP router B 415. Then, the VPN server 429 sends the data to the ISP router B 415 in step 823 and the ISP router B 415 detects the FA 423 having the IP address set in the Inform COA message and forwards the data to the FA 423 in step 825. Finally, the FA 423 forwards the data to the MN 421 referring to the IP address of the MN 421 in step 827.

In accordance with the present invention as described above, it is possible that a server in a VPN may search for an FA to which an MN belongs in real time. Therefore, the server may initiate data transmission to the MN.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method of searching for a address of a Foreign Agent (“TA”) to which a Mobile Node (“MN”) belongs, comprising:
inquiring the address of the FA to a Home Agent (“HA”) by an Internet Service Provider (“ISP”) router connected to a Virtual Private Network (“VPN”) server for transmitting data from the VPN server to a Mobile Node (“MN”)
searching for the address of the FA by the HA; and
responding the address of the FA to the Internet Service Provider (“ISP”) router connected to the VPN server by the HA.

2. The method of claim 1, the step of inquiring the address of the FA comprises the step of:
transmitting an inquire Care-Of-Address (“COA”) message by the ISP router, the inquire COA message including the address of the MN.

3. The method of claim 1, the step of responding the address of the FA comprises the step of:
transmitting an inform Care-Of-Address (“COA”) message by the HA, the inform COA message, the inform COA message including the address of the FA.

4. The method of claim 1, further comprising before the step of inquiring the address of the FA to the HA:
requesting the Internet Service Provider (“ISP”) router connected to the VPN server to search for the address of the FA to which the MN belongs.

5. The method of claim 1, further comprising after the step of responding the address of the FA to the ISP router:
routing the data to the address of the FA.

6. A method of transmitting data from a Virtual Private Network (“VPN”) server to a Mobile Node (“MN”), comprising:
requesting an Internet Service Provider (“ISP”) router connected to the VPN server to search for an address of a Foreign Agent (“FA”) to which a MN belongs, upon sensing generation of data destined for the MN in the VPN server, the requesting performed by a Customer Premise Equipment (“CPE”) router;
searching for the address of the FA through a Home Agent (“HA”) by the ISP router;
routing the data to the address of the FA by the ISP router; and
locating the MN and forwarding the data to the MN by the FA.

7. The method of claim 6, wherein the searching for the address of the FA comprises:
sending an Inquire Care-Of-Address (“COA”) message by the ISP router to the HA requesting a search for the address of the FA in response to the requesting an ISP router; and
receiving an Inform COA message by the ISP router, the Inform COA message including the address of the FA.

8. The method of claim 7, wherein the Inquire COA message includes a message type area indicating a type of a current message and a destination address area indicating an address of a destination MN.

9. The method of claim 7, wherein the Inform COA message includes a message type area indicating a type of a current message and a COA area indicating the address of the FA to which the MN belongs.

10. The method of claim 6, wherein the VPN is based on an Internet Protocol (“IP”) network.

11. The method of claim 5, wherein the address is an IP address.

12. A method of transmitting data from a Virtual Private Network (“VPN”) server to a Mobile Node (“MN”), comprising:
requesting a first Internet Service Provider (“ISP”) router connected to a Customer Premise Equipment (“CPE”) router to search for an address of a Foreign Agent (“FA”) to which a MN belongs, upon sensing generation of data destined for the MN in a VPN server, the requesting performed by the CPE router;
sending an Inquire COA message by the first ISP router to a Home Agent (“HA”), the Inquire COA message including an address of the MN and a request to search for the address of the FA;
sending an Inform COA message by the HA to the first ISP router, the Inform COA message including the address of the FA determined by referring to the address of the MN;
detecting a second ISP router to which the FA belongs and to which the first ISP router is connected; and
sending the data to the second ISP router via the first ISP router by the VPN server to forward the data to the FA by the second ISP router, and further to forward the data to the MN by the FA.

13. The method of claim 12, wherein the sending an Inquire COA message is performed in response to the requesting from the CPE router to search for the FA address, and the method further includes receiving the Inform COA message by the first ISP router.

14. The method of claim 12, wherein the Inquire COA message includes a message type area indicating a type of a current message and a destination address area indicating an address of a destination MN.

15. The method of claim 12, wherein the Inform COA message includes a message type area indicating a type of a current message and a COA area indicating the address of the FA to which the MN belongs.

16. A method of transmitting data from a Virtual Private Network (“VPN”) server to a Mobile Node (“MN”), comprising:
receiving a request from a node in a VPN to search for a Foreign Agent (“FA”) to which an MN belongs;
sending a first message including an address associated with the MN to a Home Agent (“HA”) to request for an address of a Foreign Agent (“FA”) to which the MN belongs;
receiving a second message from the HA, the second message including an FA address identified with the FA to which the MN belongs;
identifying a router corresponding to the FA address; and
allowing data to be transmitted from the node in a VPN to the MN via the router and the FA.

17. The method of claim 16, wherein the node in a VPN includes a Customer Premise Equipment (“CPE”) router.

18. The method of claim 16, wherein the allowing includes:
allowing data to be transmitted from a server in the VPN to the MN via the node in a VPN, the router, and the FA.

19. A method of transmitting data from a Virtual Private Network (“VPN”) server to a Mobile Node (“MN”), comprising:
sending a request for an address of a Foreign Agent (“FA”) to which a Mobile Node (“MN”) belongs;
receiving the address of an FA and an address of a router corresponding to the address of an FA;
transmitting data to the router to be forwarded to the MN via the address of an FA.

20. The method of claim 19, further including:
detecting generation of data destined for the MN in the VPN before the sending.
